(19) United States
(12) Patent Application Publication
(10) Pub. No.: US 2004/0055601 A1
(43) Pub. Date: Mar. 25, 2004

(54) Individual portable air purifier

(76) Inventors: Florindo De Luca, Arcore (IT); Davide De Luca, Arcore (IT)

Correspondence Address: THE BILICKI LAW FIRM, PC, FURNITURE MART BUILDING, SUITE 1000, 111 WEST SECOND STREET, JAMESTOWN, NY, 14701

(21) Appl. No.: 10/466,666

(22) PCT Filed: Jan. 16, 2002
(86) PCT No.: PCT/EP02/00373

(30) Foreign Application Priority Data
Jan. 19, 2001 (IT) MI2001 A 00097

(51) Int. Cl. A62B 18/00; A62B 7/10

(52) U.S. Cl. 128/205.22; 128/201.22; 128/201.25

(57) ABSTRACT

It is described a portable equipment for providing a user with air purified from solid and/or gaseous polluting substances, comprising at least: —a housing (1) to be worn by the user (for example hanging from his/her belt), containing at least filtering means (2) for detaining the polluting substances which are present in the air and means (3) for sending to delivery means (5) the air coming out from the filtering means (2); —means (6) connecting the housing (1) to the delivery means (5), and —the delivery means (5) to be applied on the head of the user and comprising at least a diffuser (7) for conveying the filtered air to the nose and mouth of the user (thus creating an area filled with clean air) and supporting means (8) for the diffuser (7). The equipment has limited size and weight and can be easily carried by the user without limiting his/her free movements.

### FIELD OF THE INVENTION

The present invention consists of a portable equipment for proving a user with an area filled with air purified from solid and/or gaseous polluting substances and comprising a housing containing at least means for detaining the polluting substances which are present in the air and means for sending to delivery means the air coming out from the filtering means; means for connecting the housing to the delivery means and the delivery means, to be applied on the head of the user and comprising at least a diffuser for conveying the filtered air to the user's nose and mouth (thus creating an area filled with clean air) and supporting means for the diffuser.

### PRIOR ART

The problem concerning solid and/or gaseous polluting substances that are present in the air is getting more and more serious, also involving remarkable consequences on the health. Said problem is (or can be) particularly relevant for persons involved in manufacturing processes possibly releasing polluting substances, which are at least potentially harmful to the health if the are inhaled and for persons (such as, for example, municipal policemen) which are necessarily exposed for a long time to urban polluted air.

As an example we wish to remind that, according to recent studies, in the next future about a person out of three will be affected by bronchial asthma, whereas about a person out of five will be affected by cancer in the respiratory system, particularly in lungs.

Furthermore, it has been found that an increasing number of persons are affected by allergies (hay fever, etc.) induced by pollens and/or some other allergens carried by the air.

The individual protection means that are currently available are usually uncomfortable and bulky. For instance, protection masks, which are presently among the most diffused individual protection means, represent an obstacle to breathing and their use is (or can be) therefore exhausting for the user, besides inducing respiratory crises in persons having a predisposition to them. Moreover, said masks do not allow the user to talk, eat, drink, etc. and must therefore be removed during said activities.

Collective protection means (such as, for example, air purification systems to be installed in a flat or in one or more buildings) usually involve high installation and maintenance costs and are however inefficacious when the person gets out of th area covered by the purification system.

The individual portable air purifier object of the present invention represents a valid protection against the risks related to the inhalation of polluting substances and lacks all previously mentioned drawbacks and limitations. In fact, thanks to its reduced size and weight, once worn it does not limit in any way either the fre movements or the normal activities of the user, who can therefore breath, talk, eat, drink, etc. without any kind of obstacle and/or limitations.

### SUMMARY OF THE INVENTION

It is the object of the present invention an individual portable air purifier comprising a combination of, at least, the following elements:

a housing, worn by the user, containing at least filtering means for mechanically, chemically and/or physically detaining the polluting substances which are present in the air and means for sending to delivery means the air coming out from the filtering means;

means connecting the housing to the delivery means, and the delivery means, to be applied on the head of the user and comprising at least a diffuser for conveying the filtered air to the nose and mouth of the user (thus creating an area filled with clean air) and supporting means for the diffuser.

### LIST OF THE DRAWINGS

The present invention will be described hereinafter in more detail with reference to a non-limitative embodiment shown in the alleged figures, wherein:

FIG. 1 shows a back view of an user wearing a portable air purifier according to the invention;

FIGS. 2 and 3 respectively show a front view and a side view of the user's head of FIG. 1 for better showing the delivery means;

FIG. 4 schematically shows a section of housing 1.

In the enclosed figures corresponding elements will be identified by the same numeral references.

### DETAILED DESCRIPTION

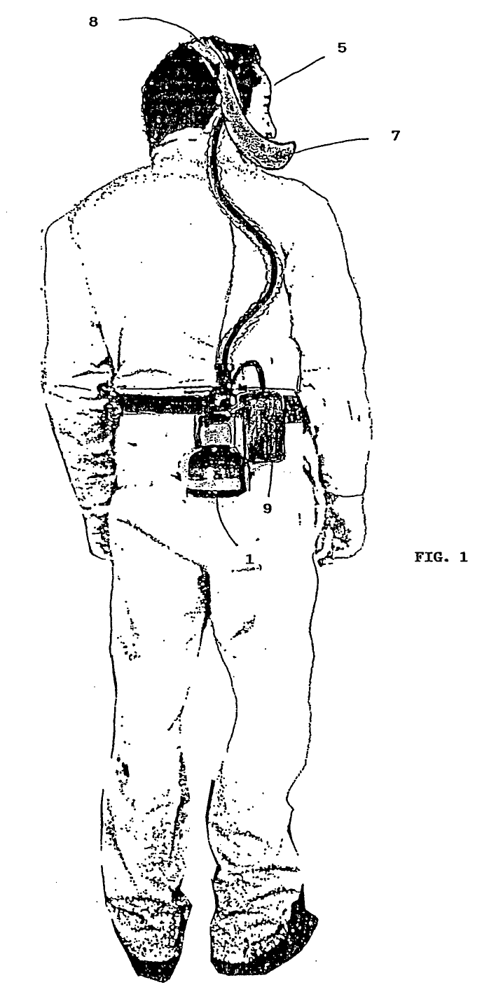

FIG. 1 shows a back view of an user wearing a portable air purifier according to the present invention, comprising at least a combination of the following elements:

a housing 1 to be worn by the user, containing at least filtering means 2 (not shown in FIG. 1) for retaining the polluting substances which are present in the air and means 3. (not shown in FIG. 1) for sending to delivery means 5 the air coming out from the filtering means 2;

means 6 connecting the housing 1 to the delivery means 5, and

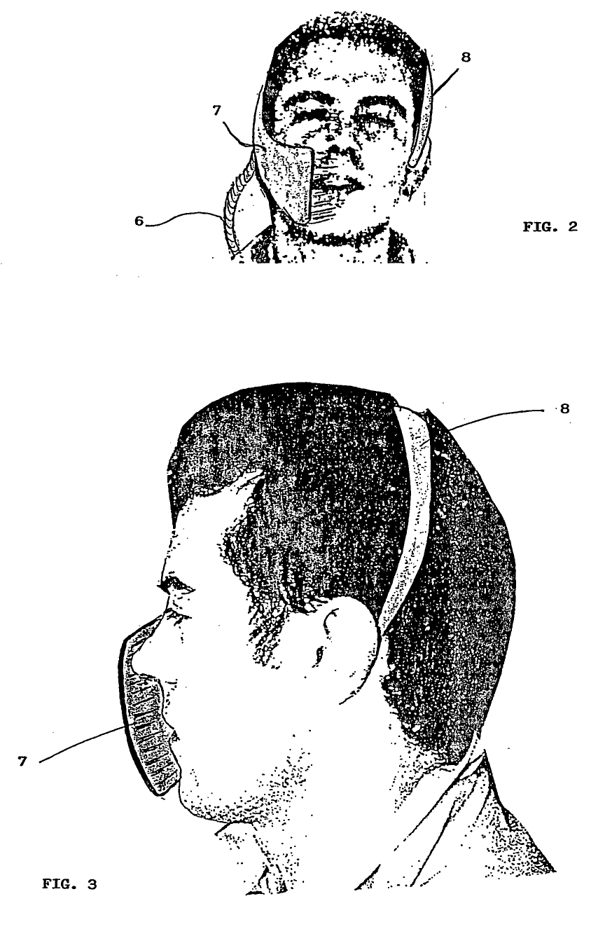

the delivery means 5 (better shown in FIGS. 2 and 3) to be applied on the head of the user and comprising at least a diffuser 7 for conveying the filtered air to the nose and mouth of the user (thus creating an area filled with clean air) and supporting means 8 for the diffuser 7.

In this embodiment the housing 1 can be hanging from the user's belt and it is connected to an external power source 9 (preferably a battery or a rechargeable accumulator) supplying the sending means 3 placed inside the housing 1; without leaving the scope of the present invention, the housing 1 can be differently worn by the user, for example it can be carried on the user's shoulder, and/or the power source 9 can be placed inside the housing 1.

Filtering means 2 comprise at least a filter, preferably but not necessarily a mechanical filter such as a multi-filter type with interchangeable cartridges, for better meeting the specific requirements of the user; without leaving the scope of the present invention it is however possible to use other kinds of filters, for example electrostatic or chemical filters.

Advantageously, the filtering means 2 can detain up to 99.9% of the polluting substances present in the air and are anyway able to detain particles of polluting substances having a diameter even smaller than 0.5 μm.

Means 3 for sending to the delivery means 5 the air coming out from filtering means 2 comprise at least a fan, preferably a multi-speed electric fan; preferably, but not necessarily, the sending means 3 can convey to the delivery means 5 an amount of air comprised between 40 and 260 I/m.

Means 6 connecting the housing 1 to the delivery means 5 are directly connected to the diffuser 7 belonging to the delivery means 5 and are formed by a flexible tubular body, preferably but not necessarily made of non-toxic plastic material (such as, for instance, nylon, polypropylene or polyethylene) or made of non-toxic rubber.

Advantageously, the flexible tubular body is formed by a flexible corrugated pipe. Diffuser 7, belonging to the delivery means 5, is supported by the supporting means 8 and has a shape apt to convey to the area directly before the user's nose and mouth a flow of purified air (coming from the connecting means 6), thus filling this area with clean air and removing from it any polluted air and gaseous products breathed out by the user, allowing therefore the user to breathe in nearly only air purified by filtering means 2.

Supporting means 8, belonging to the delivery means 5 and supporting the diffuser 7, are preferably of the kind used, for example, by phone operators (or by any other operator needing his/her hands to be free) and are essentially formed by an elastic body having a semicircular shape to be put on the user's head, on whose end the diffuser 7 is fastened.

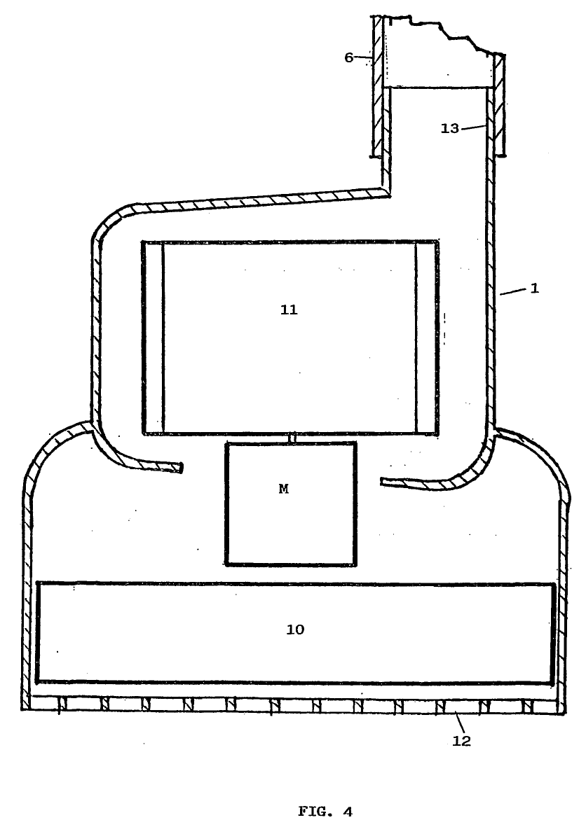

FIG. 4 shows a section of the housing 1, inside which it is schematically indicated the position of the filtering means 2 formed by a mechanical filter 10 and of the sending means 3 formed by an electric fan 11 (operated by engine M); FIG. 4 also shows the end of connecting means 6 inserted on the coupling 13 belonging to housing 1.

Without leaving the scope of the present invention, the sending means 3 can be formed by two or more electric fans. In the embodiment shown in FIG. 4 the air, sucked by the fan 11 inside the housing 1 through grating 12 (or any other functionally equivalent means) passes through the filter 10 before being sent to the pipe 6, then reaching the diffuser 7 through said pipe 6.

For simplicity's sake FIG. 4 does not show means (already known) for starting/stopping the sending means 3 and/or for adjusting their operation. If, as shown in FIG. 4, the sending means 3 are formed by the electric fan 11, said means comprise a switch and, possibly, means for continuously or non-continuously adjusting the rotating speed of fan 11 and, therefore, the air flow of the diffuser 7.

Without leaving the scope of the invention, the filtering means 2 and the sending means 3 can be formed by means different from those (a mechanical filter 10, respectively an electric fan 11) shown in FIG. 4 as a non-limitative example and/or can be differently placed inside housing 1.

Without leaving the scope of the present invention, a person skilled in the art can carry out on the individual portable air purifier of the present invention all modifications and improvements suggested by normal experience and by the natural advance of technology.

1. Individual portable air purifier comprising the following elements:
a housing (1) to be worn by the user, containing at least filtering means (2) for detaining the polluting substances which are present in the air and sending means (3) for sending to delivery means (5) the air coming out from the filtering means (2), said sending means (3) being suitable to send to the delivery means (5) an amount of air comprised between about 40 and about 260 I/m;
means (6) connecting said housing (1) to said delivery means (5), said delivery means (6), to be applied on the head of said user, comprising at least a diffuser (7) for conveying the filtered air both to the nose and mouth of said user and supporting means (8) for supporting said diffuser (7), said diffuser (7) comprising an end to be positioned closer to the nose and mouth of said user having a width great enough to cover both the nose and the mouth.

2. Air purifier according to claim 1, characterised in that the housing (1) can be hung from the users belt.

3. Air purifier according to claim 1, characterised in that the filtering means (2) comprises at least a filter.

4. Air purifier according to claim 3, characterised in that the at least a filter is a mechanical filter (10).

5. Air purifier according to claim 4, characterised in that the at least a mechanical filler (10) is of the multi-filter type with interchangeable cartridges.

6. Air purifier according to claim 1, characterised in that the filtering means (2) are suitable to detain up to 99.9% of the polluting substances present in the air.

7. Air purifier according to claim 1, characterised in that the means (3) sending to the delivery means (5) the air coming out from the filtering means (2) comprise at least a fan.

8. Air purifier according to claim 7, characterised in that the at least a fan is an electric fan (11).

9. Air purifier according to claim 8, characterised in that the at least an electric fan (11) is a multi-speed fan.

10. Air purifier according to claim 1, characterised in that the means (6) connecting the housing (1) to the delivery means (5) are formed by a flexible tubular body.

11. Air purifier according to claim 10, characterised in that the flexible tubular body is formed by a flexible corrugated pipe.

12. Air purifier according to claim 10, characterised in that the flexible tubular body is made of non-toxic plastic material.

13. Air purifier according to claim 10, characterised in that the flexible tubular body is made of non-toxic rubber.

14. Air purifier according to claim 1, characterised in that the means (6) connecting the housing (1) to the delivery means (5) are directly connected to the diffuser (7) belonging to the delivery means (5).

15. Air purifier according to claim 1, characterised in that the diffuser (7) belonging to the delivery means (5) conveys to the area directly before the user's nose and mouth a flow of air, purified by the filtering means (2), coming from the means (6) which connect the housing (1) to the delivery means (5).

16. Air purifier according to claim 1, characterised in that the means (8) belonging to the delivery means (5) and supporting the diffuser (7) are made of an elastic body having a semi-circular shape, on whose end the diffuser (7) is fastened.
